(19) United States
(12) Patent Application Publication
(10) Pub. No.: US 2008/0055416 A1
(43) Pub. Date: Mar. 6, 2008

(54) Camera, output image selection method, and recording medium storing output image selection program

(76) Inventor: Ryosaku Aoki, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/897,092

(22) Filed: Aug. 28, 2007

(30) Foreign Application Priority Data
Aug. 29, 2006 (JP) 2006-232680

(51) Int. Cl. H04N 5/225

(52) U.S. Cl. 348/207.1

(57) ABSTRACT

Upon outputting an image from a camera to an external device, a screen image (preparation screen image) for showing candidate images to be output to the external device is displayed on a display part of the camera. Then, an image selected from display images on this preparation screen is output to the external device. For example, the display images on the preparation screen image can consist of a monitor image and a plurality of recorded images.

### CROSS-REFERENCE TO RELATED APPLICATION

This application is based upon and claims the benefit of priority from prior Japanese Patent Application No. 2006-232680, filed on Aug. 29, 2006, the entire contents of which are incorporated herein by reference.

### BACKGROUND OF THE INVENTION

1. Field of the Invention

The present invention relates to a camera, an output image selection method, and a recording medium storing an output image selection program for enabling a user to select and output a desired image to an external device.

2. Description of the Related Art

Conventionally, as a method of viewing images shot with film cameras, printing out the images for viewing has been known.

On the other hand, since images shot with digital cameras are generated as electronic image data, there are various image-viewing ways other than printing out the images.

For example, since most digital cameras have a built-in display part such as a color LCD (Liquid Crystal Display), there is a method of displaying shot images on the display part to allow a user to view the shot images.

Further, many digital cameras include an interface (e.g., USB (Universal Serial Bus)) for outputting images to an external device such as a personal computer. This type of digital cameras can, as a method of viewing images, transmit image data to a personal computer to view images on a display screen of the personal computer. In this case, if a projector is connected to the personal computer, a method of displaying an enlarged image through the projector to view the image on a wall surface is also possible.

Further, some digital cameras have a video output terminal for outputting image signals to a home television set. This type of digital cameras can, as a method of viewing images, be connected to the television set with a cable to view images on a television monitor.

On the other hand, among the reasons to view images shot with digital cameras, personal pleasure is a typical one. However, viewing images in a company for joy and business use, such as presentations at business meetings and explanation of goods, are also relatively common purposes.

In recent years, image display devices for displaying images without shooting function (so-called viewers) have been commercially available. This type of display devices have a built-in display part such as a color LCD used for viewing images, for example, in a company or for business purposes as mentioned above.

Referring here to FIG. 10, a state of a conventional digital camera connected to an external device capable of displaying images is described. FIG. 10 shows a conventional example of a correspondence between a display image in a built-in display part of the digital camera and a display image displayed on the external device.

A digital camera 101 is connected through a signal cable 103 to an external device 102 capable of displaying images. In this case, an image 101a displayed on the built-in display part of the digital camera 101 is the same as an image 102a displayed on the external device 102. In other words, the digital camera 101 is configured to output, to the external device 102, the same image as that displayed on its built-in display part. Thus, in the digital camera of the type shown in FIG. 10, the built-in display part of the camera and that of the external device perform the identical functions.

On the other hand, though not shown, there is a digital camera of the type that automatically stops display on the built-in display part for power savings when the signal cable for connection to the external device is connected to the digital camera. Connecting the external device to the digital camera of this type, an operator operates the digital camera while viewing only the display of the external device to scroll the images displayed on the external device and to select a desired image in order to display the image on the external device.

In the meantime, as image playback methods, there are two well known ways. One is allowing the operator to play back images recorded on a recording medium on a frame-by-frame basis. And the other is performing playback using a slide show function for automatically and sequentially playing back images recorded on the recording medium in a predetermined order.

Among these methods, a technique for making the slide show function easier to use is disclosed, for example, in Japanese Patent Application Laid-Open No. 2003-288068. This publication teaches a technique for providing a slide show of only arbitrarily selected images in an arbitrary order according to touch operations of an operator to click checkboxes.

Further, a display method intended for the above-mentioned presentations is disclosed, for example, in Japanese Patent Application Laid-Open No. 2004-260768. This publication teaches an image playback device for displaying shot images in order according to the direction selected by the operator.

### BRIEF SUMMARY OF THE INVENTION

The camera of the present invention is configured such that, upon outputting an image to an external device, a screen (preparation screen) for showing candidate images to be output to the external device is displayed on a display part of the camera. Then, an image selected from display images on this preparation screen is output to the external device. For example, the display images on the preparation screen can consist of a monitor image (a live image) and a plurality of recorded images.

An exemplary structure of the present invention can be expressed as a camera comprising: a display part for displaying images; a preparation screen creating part for creating a screen image as a preparation screen image used in preparing an image to be output to an external device, the preparation screen image comprising a plurality of display images including recorded images and a monitor images; a display control part for causing the display part to display the preparation screen image; and an output image control part for performing control to output, to the external device as an output image, an image selected from the plurality of display images on the preparation screen image displayed on the display part.

The present invention can also be understood as the invention of an output image selection method or a recording medium recording an output image selection program.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a perspective view showing a state where an external device is connected to a camera according to a preferred embodiment of the present invention;

FIG. 2 is a block diagram showing the structure of the camera connected to the external device in the embodiment;

FIGS. 3A and 3B are views showing a display part and a television when a recorded image is selected on a multi-view preparation screen in a shooting mode of the embodiment;

FIGS. 4A and 4B are views showing the display part and the television immediately after a shooting instruction is input on condition that the multi-view preparation screen is displayed in the shooting mode of the embodiment;

FIGS. 5A and 5B are views showing the display part and the television when a monitor image is selected on the multi-view preparation screen in the shooting mode of the embodiment;

FIGS. 6A to 6C are views showing a calendar-view preparation screen as another example of the preparation screen and the screen of the television in the shooting mode of the embodiment;

FIGS. 7A and 7B are views showing a state where a recorded image selected on the multi-view preparation screen in a playback mode of the embodiment is displayed on the display part and the television;

FIGS. 8A and 8B are views showing the display part and the television immediately after the recorded image is selected on the multi-view preparation screen in the playback mode of the embodiment;

FIG. 9 is a flowchart showing the operation of the camera according to the embodiment; and

FIG. 10 is a view showing a conventional example of a correspondence between a display image on a built-in display part of a digital camera and a display image displayed on an external device.

### DETAILED DESCRIPTION OF THE PREFERRED EMBODIMENT

A preferred embodiment of the invention is described below with reference to the accompanying drawings.

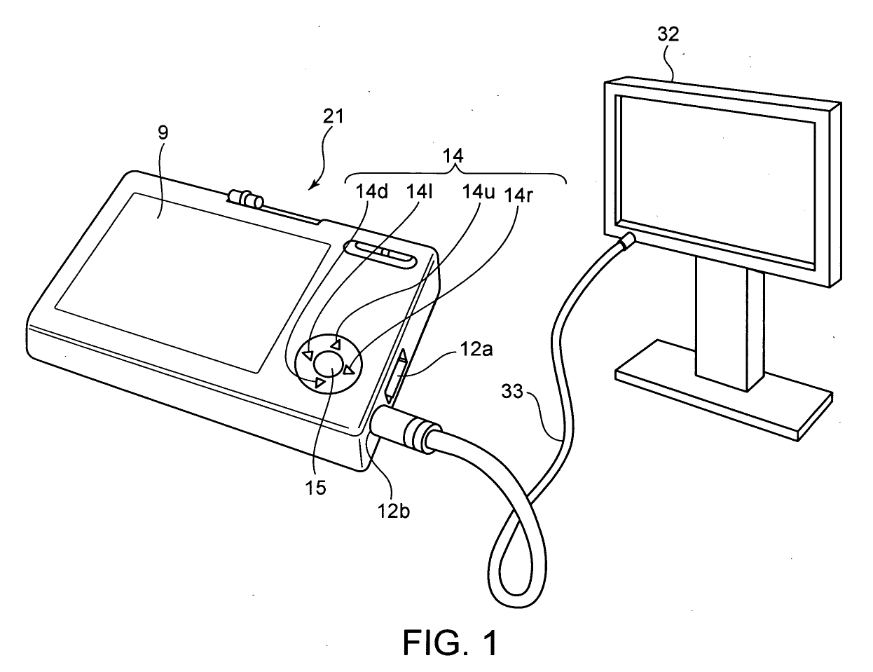

FIGS. 1 to 9 show a preferred embodiment of the present invention, in which FIG. 1 is a perspective view showing a state upon connecting an external device to a camera.

A camera 21 is, for example, a digital camera, which is connected to a television 32 as the external device through a cable 33.

This camera 21 has a display part 9 such as a color LCD, for example, on its back face. A circular arrow pad 14 and an OK button 15 provided at the center of this arrow pad 14 are provided on the lower right side of this display part 9. Here, the arrow pad 14 have an up key 14u, a down key 14d, a right key 14r, and a left key 14l.

Further, a digital output terminal 12a and an analog output terminal 12b are provided, for example, on the right-side face of the camera 21, and the cable 33 for connection to the television 32 is connected to the analog output terminal 12b.

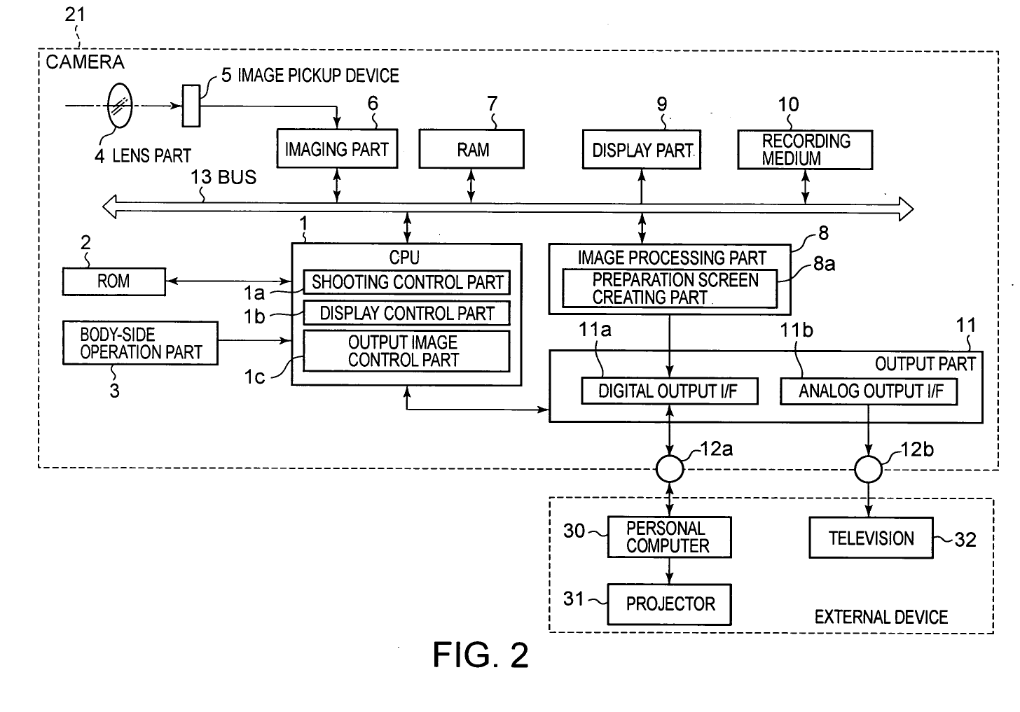

Next, FIG. 2 is a block diagram showing the structure of the camera 21 connected to external devices including the television 32.

The camera 21 includes a CPU 1, a ROM 2, a body-side operation part 3, a lens part 4, an image pickup device 5, an imaging part 6, a RAM 7, an image processing part 8, the display part 9, a recording medium 10, an output part 11, the digital output terminal 12a, the analog output terminal 12b, and a bus 13.

The CPU 1 is a control part for centralized control of this camera 21. The CPU 1 has a shooting control part 1a for control related to shooting, a display control part 1b for control related to display, and an output image control part 1c for control related to image output to the external device. Here, the shooting control part 1a, the display control part 1b, and the output image control part 1c can also be implemented by independent circuits, respectively, as hardware components in the CPU 1. Alternatively, the function of each control part can be implemented by software in such a manner that the CPU 1 executes a program corresponding to each function.

ROM 2 is a nonvolatile storage part for storing a control program executed by the CPU 1 and various data used in this camera 21. The ROM 2 is internally connected to the CPU 1.

The body-side operation part 3 is used for inputting operations to this camera 21. In addition to the above-mentioned arrow pad 14 and OK button 15, the body-side operation part 3 further includes a mode key (not shown) for setting various modes related to this camera 21, a release button (not shown) for input of a shooting instruction, a power switch (not shown) for power on or off of the camera 21, etc. The mode key can be used for setting a shooting mode, a playback mode, a presentation mode described later, a multi-view and calendar view on a preparation screen, and etc. This body-side operation part 3 is connected to the CPU 1.

The lens part 4 forms a light image of a subject.

The image pickup device 5 photoelectrically converts the subject light image formed through the lens part 4 to output an electrical analog image signal.

The imaging part 6 performs various analog signal processing on the analog image signal output from the image pickup device 5, converts the processed analog image signal to digital image data, and outputs the digital image data.

RAM 7 is a volatile storage part used by the CPU 1 as a working memory for temporary storage of image data from the imaging part 6.

The image processing part 8 performs various digital image processing on image data stored in the RAM 7. This image processing part 8 includes a preparation screen creating part 8a for creating a preparation screen image used in preparing an image to be output to the external device.

The display part 9 displays images and various information related to this camera 21 under the control of the above-mentioned display control part 1b. This display part 9 also displays, under the control of the display control part 1b, the preparation screen image created by the preparation screen creating part 8a.

The recording medium 10 is a nonvolatile recording medium for recording and holding captured images as recorded images. Recording of an image onto this recording medium 10 is performed under the control of the shooting control part 1a of the CPU 1 upon receiving input of the imaging instruction from the release button on the body-side operation part 3.

The output part 11 outputs the image data received from the image processing part 8 and other data received from the CPU 1 to the external device under the control of the output image control part 1c of the CPU 1. The output part 11 has a digital output interface (I/F) 11a for outputting digital data such as digital image data and an analog output interface (I/F) 11b for outputting analog data such as analog image data.

The digital output terminal 12a is to connect this camera 21 to the external device to which digital image data and the like from the digital output interface (I/F) 11a are output. In this example shown in FIG. 2, a personal computer 30 and a projector 31 connected to this personal computer 30 are illustrated as examples of the external device to which digital image data and the like are output.

The analog output terminal 12b is to connect this camera 21 to the external device to which analog image data and the like from the analog output interface (I/F) 11b are output. In this example shown in FIG. 2, a television 32 is illustrated as an example of the external device to which analog image data and the like are output. As the structure of the external device, either a plurality of external devices as shown in FIG. 2 or a single device can be connected.

The bus 13 interconnects the CPU 1, the imaging part 6, the RAM 7, the image processing part 8, the display part 9, and the recording medium 10 in such a manner that image data and various kinds of instructions are transferred therethrough.

The following describes the operation of this camera 21.

First, a shooting operation in the shooting mode is described.

When the power switch on the body-side operation part 3 is turned on and the camera 21 is set in the shooting mode, a subject image formed through the lens part 4 is captured by the image pickup device 5, processed by the imaging part 6, and stored in the RAM 7.

The image stored in this RAM 7 is processed by the image processing part 8 as a monitor image and output to the display part 9 under the control of the display control part 1b, thus displaying the monitor image on the display part 9.

After that, if the shooting, or imaging, instruction is input from the release button on the body-side operation part 3, the image stored in the RAM 7 through the image pickup device 5 and the imaging part 6 in the manner mentioned above is processed by the image processing part 8 such as to be compressed for image recording under the control of the shooting control part 1a. After that, the image is recorded on the recording medium 10. Note that the image recorded on the recording medium 10 is referred to as the recorded image below.

Next, an operation upon playback of the recorded image in the playback mode is described.

When the camera 21 is set in the playback mode, the recorded image on the recording medium 10 is read out, processed by the image processing part 8 such as to be decompressed, and stored in the RAM 7 under the control of the display control part 1b.

The image stored in this RAM 7 is processed by the image processing part 8 as an image to be displayed on the display part 9, and output to the display part 9, thus playback-displaying the recorded image on the display part 9.

At this time, other recorded images recorded on the recording medium 10 can also be played back by operating, for example, the above-mentioned arrow pad 14 on the body-side operation part 3.

In both the above-mentioned shooting and playback modes, this camera 21 can display a preparation screen image by further operating the mode key on the body-side operation part 3 to set the presentation mode. This preparation screen image is for showing, on the display part 9, a plurality of display images as candidates to be output to the external device to enable the operator to select and output a desired image with simple operations. The plurality of display images on this preparation screen image include the recorded images, and if the camera 21 is in the shooting mode, the monitor image is also included. The preparation screen is image useful, for example, in making a presentation or the like. The following describes the operation upon displaying such a preparation screen image.

First, in the playback mode, if the preparation screen display is selected by operating the mode key on the body-side operation part 3, the preparation screen creating part 8a reads a plurality of recorded images from the recording medium 10 to generate display images to be displayed on the preparation screen image under the control of the display control part 1b. Then, the preparation screen creating part 8a arranges the generated display images, for example, at least in a line in either a vertical direction or a horizontal direction to create a preparation screen image in a multi-screen format. Note that the preparation screen creating part 8a can also create a preparation screen image in a calendar format to be described later instead of the preparation screen image in the multi-screen format.

The preparation screen thus created is output to and displayed on the display part 9 under the control of the display control part 1b. In such a state that the preparation screen image is displayed on the display part 9, the operator can point to (specify) any display image, for example, by operating the arrow pad 14 on the body-side operation part 3. Further, the operator can select the pointed display image by pressing the OK button 15. As a result, under the control of the output image control part 1c, the recorded image corresponding to the selected display image is read out from the recording medium, decompressed by the image processing part 8 as needed, and output to the output part 11.

Then, under the control of the output image control part 1c, the output part 11 outputs the selected image data through the digital output interface 11a on condition that the external device is connected to the digital output terminal 12a. On the other hand, if the external device is connected to the analog output terminal 12b, the output part 11 outputs image data through the analog output interface 11b after conversion of the image data to an analog signal.

Further, if the preparation screen display is selected in the shooting mode, the preparation screen creating part 8a generates not only display images based on the recorded images but also a display image based on the monitor image captured in real time through the image pickup device 5 and the imaging part 6 to create a preparation screen image using both display images. Thus, the point different in operation between the shooting mode and the playback mode is whether the display image based on the monitor image is included in the preparation screen image or not. Further, since the monitor image is added in the shooting mode, the layout or the like of the preparation screen is also slightly different from that in the playback mode. These differences are described below with reference to specific examples.

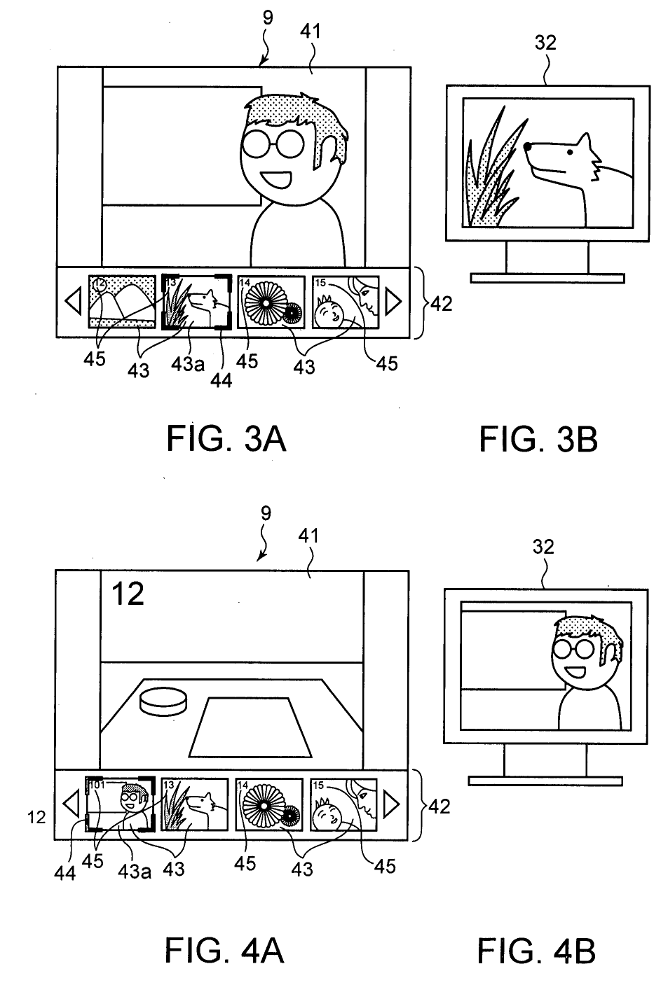

Referring to FIGS. 3A to 8B, some configuration examples of the preparation screen are described.

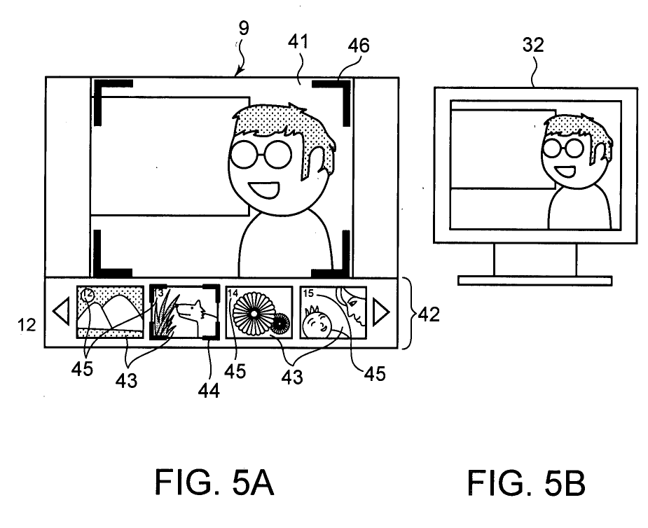

First, FIGS. 3A to 5B show states of a multi-view preparation screen image in the shooting mode. FIGS. 3A and 3B show a state upon selecting a recorded image on the multi-view preparation screen image in the shooting mode, in which FIG. 3A shows the state of the display part 9 and FIG. 3B shows the state of the television 32. FIGS. 4A and 4B show a state of the multi-view preparation screen image in the shooting mode immediately after a shooting instruction is input, where FIG. 4A shows the state of the display part 9 and FIG. 4B shows the state of the television 32. FIGS. 5A and 5B show a state upon selecting the monitor image on the multi-view preparation screen image in the shooting mode, where FIG. 5A shows the state of the display part 9 and FIG. 5B shows the state of the television 32.

As shown, on the multi-view preparation screen image in the shooting mode, a monitor image 41 is displayed on the display part 9 in a large size (in a size larger than the display size of recorded images 43 to be described later) and a horizontally-long recorded image area 42 is provided, for example, on the lower side of this monitor image 41.

In this recorded image area 42, a plurality of recorded images 43 (four recorded images in the examples shown in FIGS. 3A, 4A, and 5A) are arranged in the horizontal direction. In addition, triangular icons are displayed at both the left and right ends of the recorded image area 42 to indicate that the recorded images 43 can be scrolled. Then, an image number 45 indicating each of the recorded images 43 is displayed in each of the recorded image 43, for example, at the upper left thereof. For example, as shown in FIG. 3A, the recorded images 43 are displayed in the recorded image area 42 in order of the image number 45. However, the order of the display of the recorded images 43 is not limited thereto, and any other order is possible as long as it can sort the recorded images 43. Note further that there is an exception in the display order of the recorded image 43 as will be described with reference to FIG. 4A and etc.

If the number of recorded images 43 recorded on the recording medium 10 is more than four, all the recorded images 43 cannot be displayed in this recorded image area 42. In this case, for example, the up key 14u and the down key 14d of the arrow pad 14 can be operated to scroll the recorded images 43 displayed within the recorded image area 42.

Further, a cursor 44 is displayed to indicate that attention is given to any one of the recorded images 43, i.e., any one of the recorded images 43 is pointed in the recorded image area 42. Note that, in the examples shown in FIGS. 3A, 4A, and 5A, the cursor 44 is comprised of heavy-line corner marks displayed at the four corners of the corresponding image, but the present invention is not limited to this display style. This cursor 44 can be moved from one recorded image 43 to another, for example, by operating the left key 14l and the right key 14r of the arrow pad 14. On condition that the cursor 44 points to the recorded image 43 at the left end in the recorded image area 42, if the left key 14l is further operated, the recorded image area 42 can be scrolled to the left. On the other hand, if the right key 14r is operated on condition that the cursor 44 points to the recorded image 43 at the right end, the recorded image area 42 can be scrolled to the right.

Then, when the cursor 44 comes to the recorded image 43 the operator wants to display on the external device, the operator can, for example, press the OK button 15 to set the recorded image as a selected image in order to display the selected image on the external device (e.g., on the television 32) as shown in FIG. 3B.

Next, in the state shown in FIG. 3A, if the shooting instruction is input from the release button on the body-side operation part 3, the shooting control part 1a adds the image of the monitor image 41 as a new image of the recorded images so that the image processing part 8 processes the monitor image under the control of the shooting control part 1a. As a result, the image corresponding to the monitor image 41 is recorded on the recording medium 10 as a newly recorded image 43. It is assumed in FIG. 4A that the image number 45 of this newly recorded image 43 is “101.” Note that since the reference numeral 45 representing the image number is confusable with the numerical value of the image number (“101” in this example), the following may omit the reference numeral 45.

Further, the preparation screen creating part 8a creates a new preparation screen image to include this new recorded image 43 in the recorded image area 42, and the display control part 1b causes the display part 9 to display the newly created preparation screen image thereon.

In other words, the state shown in FIG. 3A is that four recorded images 43 having image numbers “12” to “15” are displayed by image number. Then, the newly recorded image 43 shot while the monitor image 41 is being displayed on the preparation screen image in the shooting mode is displayed, for example, at the leftmost position of the recorded image area 42 as shown in FIG. 4A regardless of the image number. This allows the operator to select the new recorded image 43 immediately after shot without scrolling many recorded images 43, thereby improving operationality.

The state shown in FIGS. 4A and 4B is that after the new recorded image 43 of image number “101” is displayed in the recorded image area 42, the cursor 44 is moved to this new recorded image 43 by operating the left key 14l and the right key 14r in the manner mentioned above, and after it is moved, the OK button 15 is pressed. The cursor 44 can also be automatically moved onto the new recorded image 43 so that the operator will have only to press the OK button 15, thereby further improving operationality.

Then, after the OK button 15 is pressed, the new recorded image 43 is displayed on the television 32 as the external device as shown in FIG. 4B.

Next, FIGS. 5A and 5B show a state upon selecting the monitor image 41 as an image to be output to the external device.

For example, in the state shown in FIG. 3A, if the monitor image 41 is selected via the body-side operation part 3, a new cursor 46 is displayed around the monitor image 41 as shown in FIG. 5A, and the selected monitor image 41 is displayed on the television 32 as the external device as shown in FIG. 5B. At this time, the cursor 44 for the recorded image continues to be displayed.

Thus, the preparation screen image in the shooting mode allows the operator to alternatively select any one of the recorded images 43 already recorded on the recording medium 10, the recorded image 43 newly shot and recorded on the recording medium 10, or the monitor image 41, so that the selected image is output to and displayed on the external device.

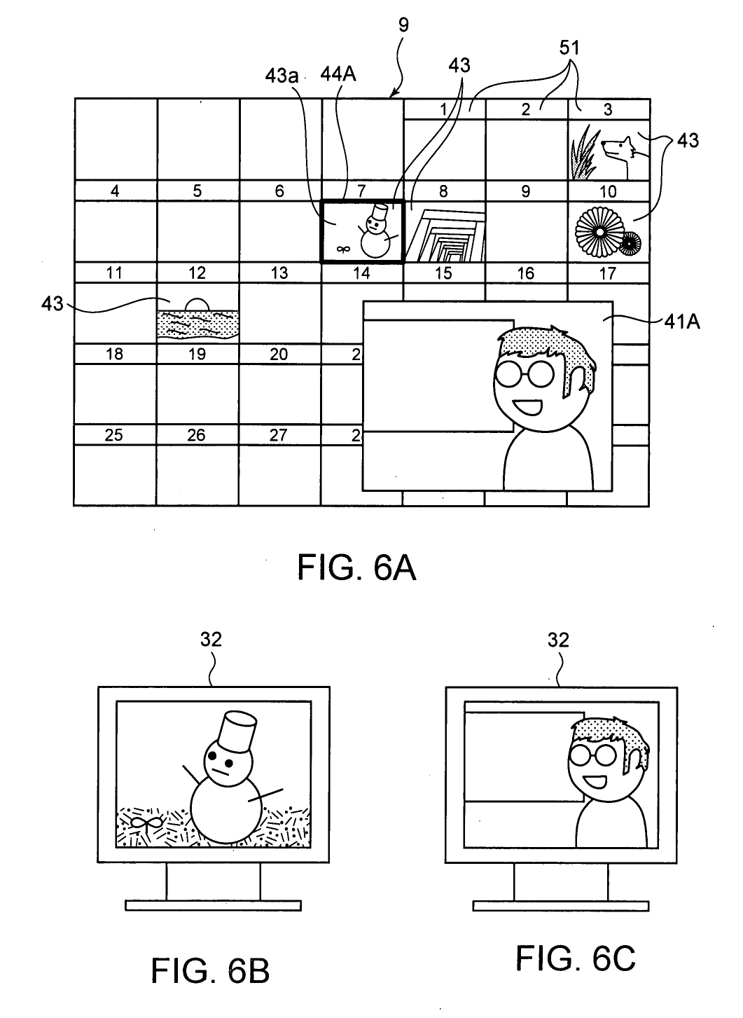

FIG. 6 shows a state of a calendar-view preparation screen as another example of the preparation screen in the shooting mode and a state of the screen of the television 32.

For example, a calendar-view preparation screen image as shown in FIG. 6 is selectable as one of the preparation screen images in the shooting mode in addition to that described with reference to the above-mentioned FIGS. 3A, 4A, and 5A. This selection is made on the body-side operation part 3.

As shown in FIG. 6A, the calendar-view preparation screen image is in the calendar format in which the recorded images 43 are grouped and arranged based on the shooting date and time.

If this calendar-view preparation screen image is selected, days 51 are displayed on the display part 9 day of the week. In other words, the calendar has days 51 in the same week lined up in the horizontal direction, and weeks arranged in the vertical direction in ascending numeric order of the days 51.

Then, an area for displaying a thumbnail image is provided below each day 51, so that if there is a recorded image 43 shot on the day, the recorded image 43 is displayed in the area as the thumbnail image.

Note that if a plurality of recorded images 43 are shot on the same day 51, a representative image of the plurality of recorded images 43 (e.g., the earliest shot image on the day) is displayed. Further, if a cursor 44A (displayed in the example of FIG. 6 as a heavy-line box surrounding the image) is moved and the OK button 15 is pressed, a plurality of recorded images 43 shot on the day 51 concerned are displayed, for example, in order of shooting time.

Thus, if the cursor 44A is moved to any one of the recorded images 43 and the OK button 15 is pressed, the recorded image 43 concerned is output to and displayed on the external device as a selected image 43a, for example, on the television 32 as the external device as shown in FIG. 6B.

A monitor image 41A is also displayed on the calendar-view preparation screen. Like in the example shown in FIGS. 3A, 4A, and 5A, this monitor image 41A is displayed in a size larger than the recorded images 43. Note that this calendar-view preparation screen image needs substantially the entire display area of the display part 9 to display the recorded images 43 on a day 51 basis, so that the monitor image 41A is superimposed on the calendar composed of the areas of the days 51 in this example shown in FIG. 6. However, since recorded images 43 located under the monitor image 41A cannot be viewed, if there is a data portion in which no recorded image 43 is present, the monitor image 41A is imposed on the data portion, for example. On the other hand, if there is no data portion in which no recorded image 43 is present, or if the area of the data portion in which no recorded image 43 is too small, the monitor image 41A is, for example, automatically moved into an area in which it does not overlap the cursor 44A according to the movement of the cursor 44A. Note that this camera can be configured that the monitor image 41A can be manually moved to a desired position.

Like in FIGS. 5A and 5B, this monitor image 41A is also selectable as the image to be output to the external device. If the monitor image 41A is selected, the monitor image is displayed on the television 32 as the external device as shown in FIG. 6C.

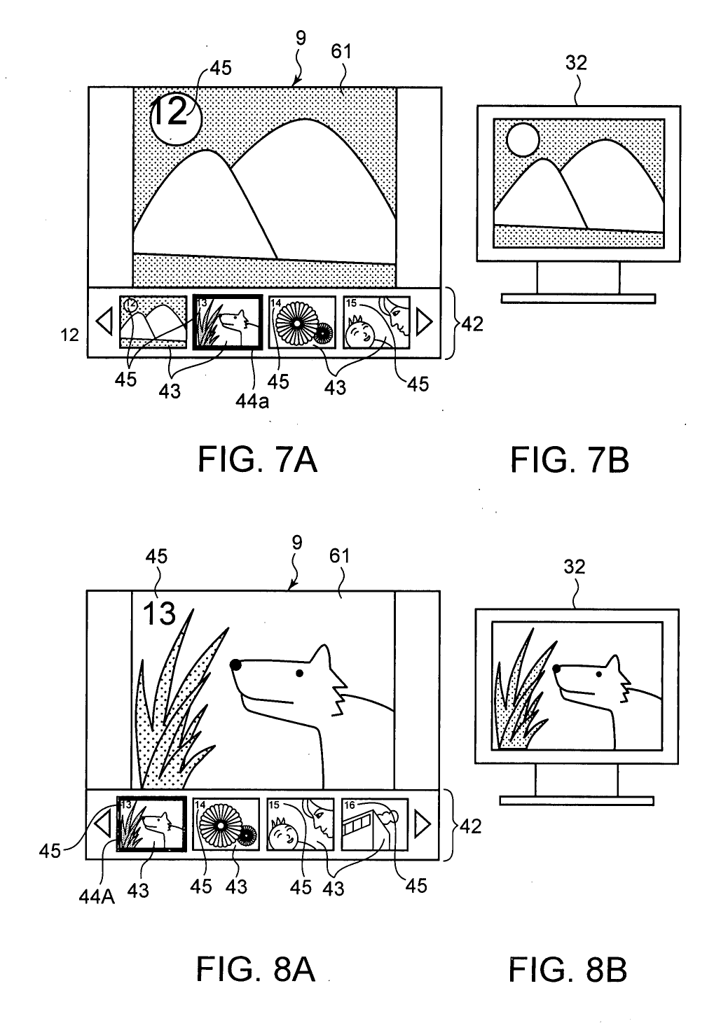

Next, FIGS. 7A to 8B show a state of the multi-view preparation screen image in the playback mode. FIGS. 7A and 7B show a state when a recorded image selected on the multi-view preparation screen image in the playback mode is displayed on both the display part 9 and the television 32. FIGS. 8A and 8B show the display part 9 and the television 32 immediately after the recorded image is selected on the multi-view preparation screen image in the playback mode.

Unlike the multi-view preparation screen image in the shooting mode as shown in FIGS. 3A, 4A, and 5A, the multi-view preparation screen image in the playback mode does not include the monitor image 41. Then, as shown in 7A, an image 61 (also see FIG. 7B) currently output into the television 32 as the external device is displayed in the area in which the monitor image 41 is displayed in FIGS. 3A, 4A, and 5A. Since this image 61 is one of the recorded images 43, its image number 45 is shown at an upper left position of the image 61.

Note that the state of the recorded image area 42 is almost the same as that in FIG. 3A except that the shape of the cursor 44A is different from that of the cursor 44 in FIG. 3A.

In the example shown in FIG. 7A, a recorded image 43 of image number “12” displayed at the left end of the recorded image area 42 is set as the image 61 to be output to the external device, but the cursor 44A is on a recorded image 43 of image number “13” located on the right side of the recorded image 43 set as the image 61. Since the cursor 44A functions as a pointer for selecting the next image to be output to the external device, it can be moved independently of the image currently output on the external device. The same holds true with regard to the cursors 44 and 44A shown in the above-mentioned FIGS. 3A, 4A, 5A, and 6A. Therefore, it is understood that the image pointed by the cursor 44A (the recorded image 43 of image number “13”) is not confirmed yet in FIG. 7A.

Next, FIGS. 8A and 8B show a state upon selecting the recorded image 43 of image number “13” by moving the cursor 44A onto the recorded image 43 concerned and pressing the OK button 15. At this time, as shown in FIG. 8A, the recorded image 43 of image number “13” becomes the image 61 to be output to the external device, and is enlarged and displayed on the display part 9. Then, as shown in FIG. 8B, the same image is also displayed on the television 32 as the external device.

Further, when the recorded image 43 of image number “13” is selected, the display of each recorded image 43 in the recorded image area 42 is automatically updated to display the selected recorded image 43 at the left end of the recorded image area 42. Therefore, in the example shown in FIG. 8A, the recorded images 43 shown in FIG. 7A are moved one by one to the left in such a manner that the image of image number “12” positioned at the left end in FIG. 7A disappears from the recorded image area 42 and a recorded image 43 of image number “16” is newly displayed at the right end of the recorded image area 42.

This processing operation can save some scrolling operations upon selecting the next recorded image 43. Note that, though not shown, this type of operational improvement is also included in the multi-view preparation screen image in the shooting mode as shown in FIGS. 3A, 4A, and 5A.

Further, though also not shown, the calendar-view preparation screen as shown in FIG. 6A can also be displayed in this playback mode as well as in the shooting mode. The calendar-view preparation screen in this playback mode becomes such a preparation screen image that the display of the monitor image 41A is omitted from the calendar-view preparation screen in the shooting mode shown in FIG. 6A.

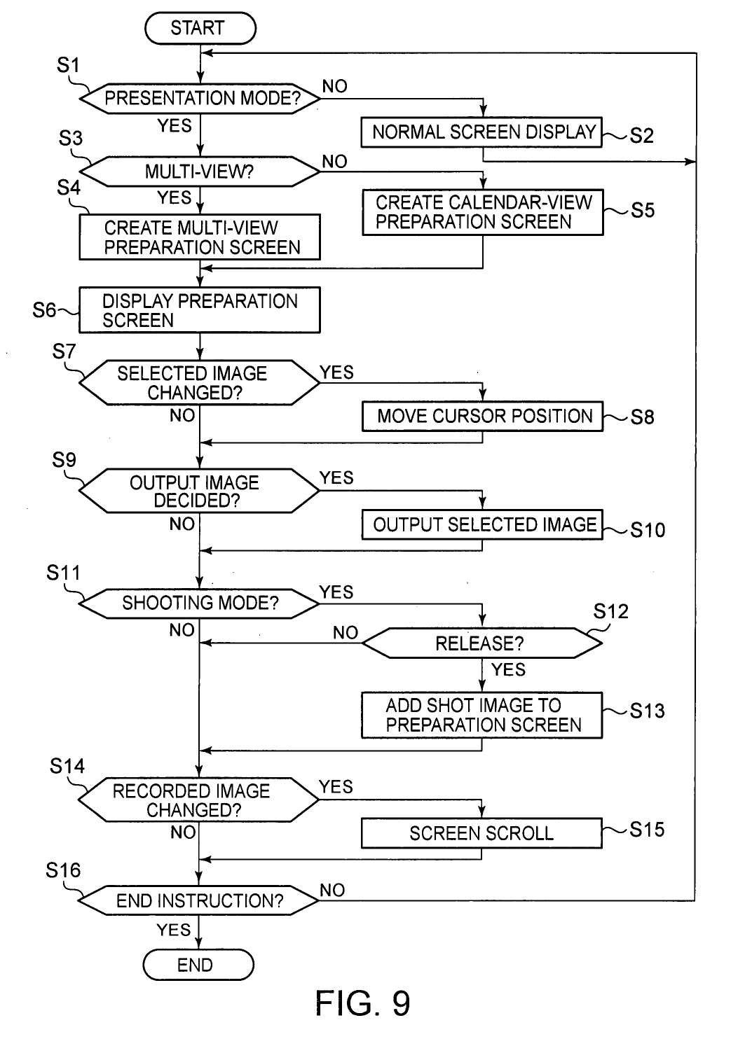

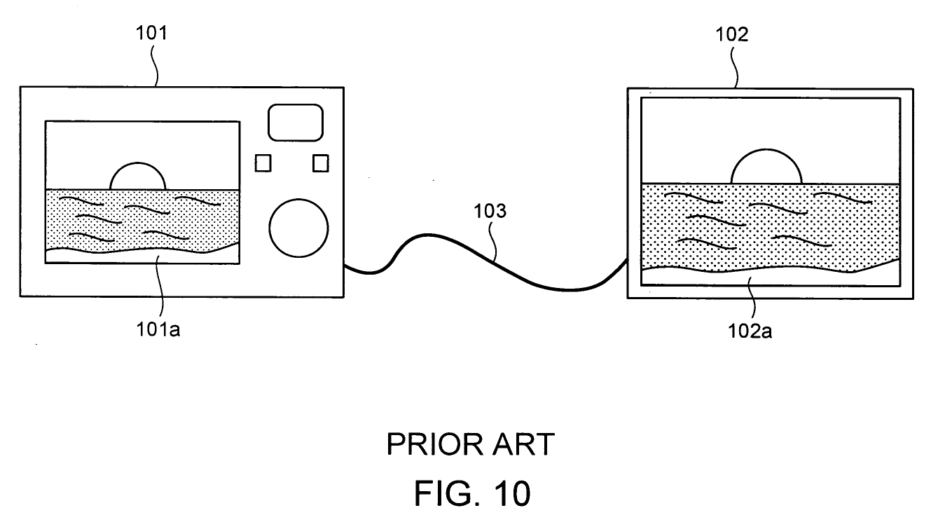

FIG. 9 is a flowchart showing the operation of the camera 21. Processing is started when the camera 21 is powered on. After start of this processing, the CPU 1 determines whether this camera 21 is set in the presentation mode by operating any mode key of the body-side operation part 3 (step S1).

Here, if it is determined that the camera 21 is not set in the presentation mode, a normal screen display is provided on the display part 9 (step S2), and at appropriate time intervals, the determination in step S1 is repeated.

On the other hand, if it is determined in step S1 that the camera 21 is set in the presentation mode, the CPU 1 further determines whether the multi-view display is set for the preparation screen image by operating any mode key of the body-side operation part 3 (step S3).

Here, if it is determined that the multi-view display is set, the preparation screen creating part 8a creates a multi-view preparation screen image under the control of the display control part 1b as shown in FIGS. 3A, 4A, and 5A (step S4).

On the other hand, if it is determined in step S3 that the multi-view display is not set, the preparation screen creating part 8a creates a calendar-view preparation screen image as shown in FIG. 6A under the control of the display control part 1b (step S5).

After completion of the processing of either of step S4 or step S5, the preparation screen created image by the preparation screen creating part 8a is displayed on the display part 9 under the control of the display control part 1b (step S6).

Then, the CPU 1 determines whether the left key 14l or the right key 14r of the arrow pad 14 has been operated to change the selected image (step S7). If it is determined that the operation to change the selected image has been performed, the display control part 1b controls the preparation screen creating part 8a to provide a display for moving the cursor position (step S8).

After completion of the processing of step S8, or if it is determined that the operation to change the selected image has not been performed, the CPU 1 then determines whether an image to be output to the external device has been decided by pressing the OK button 15 (step S9).

If it is determined that the image to be output to the external device has been decided, the output part 11 outputs the selected image under the control of the output image control part 1c (step S10).

After completion of this processing of step S10, or it is determined in step S9 that the image to be output to the external device has not been decided, it is then determined whether this camera 21 is set in the shooting mode (step S11).

If it is determined that the camera 21 is set in the shooting mode, it is then determined whether the shooting instruction has been input from the release button on the body-side operation part 3 (step S12).

If it is determined in step S12 that the shooting instruction has been input, an image corresponding to the monitor image is recorded on the recording medium 10 as a new recorded image under the control of the shooting control part 1a. Further, under the control of the display control part 1b, the preparation screen creating part 8a adds the image onto the preparation screen image and displays the image on the display part 9 (step S13).

After completion of this processing of step S13, or if it is determined step S11 that the camera 21 is not set in the shooting mode, or if it is determined in step S12 that the imaging instruction has not been input, the CPU 1 then determines whether scrolling operation using the up key 14u or the down key 14d of the arrow pad 14 has been performed to change the display of the recorded image (step S14).

If it is determined in step S14 that the operation to change the recorded image has been performed, the screen is scrolled to display another recorded image (step S15).

After completion of this processing of step S15, or if it is determined in step S14 that the operation to change the recorded image has not been performed, the CPU 1 then determines whether an instruction to end this sequence of processing operations has been input through the body-side operation part 3 (step S16). If it is determined that no instruction to end the sequence of processing operations has been input, the procedure returns to step S1 to repeat the above-mentioned processing steps, while if it is determined that the instruction to end the sequence of processing operations has been input, this processing is ended.

In the above-mentioned example, a plurality of recorded images are arranged in the horizontal direction on the preparation screen in the multi-screen format (multi-view preparation screen), but the present invention is not limited to this arrangement. The recorded images may be arranged in the vertical direction, or two-dimensionally in both the vertical and horizontal directions.

Further, the above description is made mainly with reference to the case where the recorded images are still images, but the above-mentioned technique can also be applied to such a case that the recorded images are moving images. In this case, the first frame of the moving image may be displayed on the preparation screen image as a still image, or the moving image may be displayed in the form of thumbnails. Thus, the recorded images displayed on the preparation screen may consist of only still images or moving images, or a mixture of still images and moving images. Therefore, the camera can be a camcorder as well as the digital camera, or other various types of equipment having a camera function.

Furthermore, the recorded images are not limited to the images shot with the camera 21 itself. For example, the recorded images can also be character images or computer graphics such as a title or the like created on the computer as the external device. In this case, the created image can be transferred as a recorded image to the recording medium 10 in the camera 21.

According to the embodiment described above, a plurality of recorded images are selectably displayed on the preparation screen of the camera, and only the image selected from among these recorded images is output to the external device. This allows the operator to easily select a image to show other persons and a image not to show other persons separately in order to output the selected image to the external device in a desired order.

Further, since the monitor image is also displayed on the preparation screen image in the shooting mode, the operator can not only record the monitor image immediately on the recording medium as a new recorded image by operating the release button, but also output it to the external device. Alternatively, it is also possible to output the monitor image itself in real time to the external device. Therefore, for example, a real-time image can be displayed in a presentation room by combining it with prepared material images right on the spot.

Since the monitor image is displayed on the preparation screen image of the camera during image output to the external device, it is less likely for the operator to miss the timing to operate the release button. Further, since the monitor image is displayed in a size larger than the size of the recorded images, the operator can take a close look at a subject to be shot.

In addition, since the recorded image shot while viewing the monitor image on the preparation screen in the shooting mode is displayed on the preparation screen immediately after shot regardless of its image number, the operator can select the shot image immediately and easily without scrolling many recorded images.

On the preparation screen image in the multi-screen format, since the plurality of recorded images are arranged, the operator can select a desired image to be output to the external device at the operator's discretion while collectively viewing the plurality of images.

On the other hand, on the preparation screen image in the calendar format, since the recorded images are grouped and arranged based on the shooting date and time, the operator can select an image to be output to the external device in an easy-to-operate manner.

While the above description is made mainly with respect to the camera, the above-mentioned technique can also be applied to an output image selection method for the camera, or to an output image program for causing a computer to execute this method.

The present invention can be suitably used for a camera for enabling an operator to select and output a desired image to an external device, an output image selection method, and an output image selection program.

While there has been shown and described what is considered to be a preferred embodiment of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A camera comprising:
a display part for displaying images;
a preparation screen creating part for creating a screen image as a preparation screen image used in preparing an image to be output to an external device, the preparation screen image comprising a plurality of display images including recorded images and a monitor image;
a display control part for causing the display part to display the preparation screen image; and
an output image control part for controlling to output, to the external device as an output image, an image selected from the plurality of display images on the preparation screen image displayed on the display part.

2. The camera according to claim 1, wherein the display control part causes the display part to continue to display the preparation screen image during output of the output image to the external device.

3. The camera according to claim 1, further comprising
a shooting control part for controlling an image corresponding to the monitor image to be made a recorded image upon receiving a shooting instruction while the preparation screen is being displayed, wherein
the preparation screen creating part creates a new preparation screen image to include the recorded image corresponding to the monitor image in the plurality of display images, and
the display control part causes the display part to display the new preparation screen image created.

4. The camera according to claim 1, wherein
the preparation screen creating part creates the preparation screen image in such a manner that the display size of the monitor image is larger than the display size of the recorded images.

5. The camera according to claim 1, wherein
the preparation screen creating part creates the preparation screen image in a multi-screen format in which the recorded images are arranged in at least either a vertical direction or a horizontal direction.

6. The camera according to claim 1, wherein
the preparation screen creating part creates the preparation screen image in a calendar format in which the recorded images are grouped and arranged based on the shooting date and time.

7. An output image selection method for selecting an image to be output to an external device from a camera including a display part for displaying images, the method comprising:
creating a screen including image as a preparation screen used in preparing an image to be output to the external device, the preparation screen image comprising a plurality of display images including recorded images and a monitor image;
causing the display part to display the preparation screen image, and
outputting, to the external device as an output image, an image selected from the plurality of display images on the preparation screen image displayed on the display part.

8. A recording medium storing an output image selection program for causing a computer to execute an output image selection method for selecting an image to be output to an external device from a camera including a display part for displaying images, the program causing the computer to execute:
creating a screen image as a preparation screen image used in preparing an image to be output to the external device, the preparation screen image comprising a plurality of display images including recorded images and a monitor image;
causing the display part to display the preparation screen image, and
outputting, to the external device as an output image, an image selected from the plurality of display images on the preparation screen image displayed on the display part.
